(19) United States
(12) Patent Application Publication
(10) Pub. No.: US 2008/0112187 A1
(43) Pub. Date: May 15, 2008

(54) Backlight Unit and Display Apparatus Having the Same

(75) Inventors: Toshinobu Katsumata, Fujiyoshida-shi (JP); Junji Miyashita, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd., Fujiyoshida-shi (JP)

(21) Appl. No.: 11/939,949

(22) Filed: Nov. 14, 2007

(30) Foreign Application Priority Data
Nov. 15, 2006 (JP) JP2006-308604

(51) Int. Cl. F21V 7/04

(52) U.S. Cl. 362/611

(57) ABSTRACT

A backlight unit can change the directional characteristics of exiting light by selectively turning on two light sources. The backlight unit includes a first prism sheet (4) having on a lower surface thereof a plurality of parallel prisms (3), a first lightguide plate (5) disposed underneath the first prism sheet (4), a second prism sheet (6) disposed underneath the first lightguide plate (5) and having on a lower surface thereof a plurality of parallel prisms (3), a second lightguide plate (7) disposed underneath the second prism sheet (6), a first light source (8) disposed adjacent to an edge surface of the first lightguide plate (5) to emit light into the first lightguide plate (5), and a second light source (9) disposed adjacent to an edge surface of the second lightguide plate (7) to emit light into the second lightguide plate (7).

This application claims priority under 35 U.S.C. § 119 to Japanese Patent application No. JP 2006-308604 filed on Nov. 15, 2006, the entire contents of which are hereby incorporated by reference.

### TECHNICAL FIELD

The present invention relates to a backlight unit of a display apparatus for suitable use in car navigation systems, for example, and also relates to a display apparatus having the backlight unit.

### RELATED CONVENTIONAL ART

Liquid crystal display apparatus for image display have been widely used in car navigation systems, on-board liquid crystal television systems, displays of personal computers, mobile phones, personal digital assistants (PDAs), etc. These liquid crystal display apparatus employ a backlight unit that applies illuminating light to a liquid crystal display panel from the back thereof to enhance the luminance of the display screen.

Recently, there has been a demand that liquid crystal display apparatus allow an arbitrary choice between visibility of the display screen as viewed from directly in front of it and visibility thereof as viewed obliquely sideways according to the use environment of the apparatus.

For example, a mobile phone user may want to see an image or information displayed on the liquid crystal display of the phone privately without another person looking at it sideways during use. There are also cases where a mobile phone user wants to see the displayed image or information together with other people. For the display of a car navigation system, the user may want it to be visible from a desired position, e.g. the driver's seat, the passenger's seat, or the back seat.

Japanese Patent Application Publication No. 2006-66282 proposes a backlight unit having a lightguide plate formed with a plurality of mutually parallel ridges each comprising a smooth first slant surface and a rugged second slant surface. The backlight unit further has linear first and second light sources disposed parallel to the ridges on both sides of the lightguide plate. In this backlight unit, light from the first light source is made incident on the smooth first slant surface to obtain exiting light of high directivity, and light from the second light source is made incident on the rugged second slant surface to obtain exiting light of low directivity. That is, the incident light on the rugged second slant surface is diffused when reflected therefrom. Accordingly, the proposed backlight unit enables the user to choose arbitrarily between two viewing modes by switching between the first light source and the second light sources. More specifically, when there is a watcher around the user, the backlight unit allows an arbitrary choice between a mode in which only the user can view the display and a mode in which not only the user but also another watcher can view it.

The above-described conventional backlight unit, however, still has the following problems to be solved.

When light is applied to the rugged second slant surface, directivity having a luminance peak at a position directly in front of the display screen is low. Hence, the display screen can be viewed over a wide angle range, but it is difficult to enhance only visibility of the display screen as viewed obliquely sideways while lowering visibility thereof as seen from the directly front side. In the case of a car navigation system, for example, the display is generally installed in the center of the instrument panel of a vehicle, i.e. between the driver's seat and the passenger's seat. Therefore, the display screen is demanded to provide high visibility when it is viewed obliquely sideways, i.e. when it is seen from both the driver in the driver's seat and the occupant in the passenger's seat. Accordingly, the above-described conventional backlight unit is unsuitable for use in such car navigation systems.

The present invention has been made in view of the above-described circumstances.

Accordingly, an object of the present invention is to provide a backlight unit capable of arbitrarily switching between emission of light having high directivity in a single direction and emission of light having directivity in two directions.

Another object of the present invention is to provide a display apparatus having the above-described backlight unit.

### SUMMARY OF THE INVENTION

The present invention provides a backlight unit including a first prism sheet, a first lightguide plate, a second prism sheet, a second lightguide plate, a first light source, and a second light source. The first prism sheet has a lower surface that has a plurality of mutually parallel elongated prisms. The first lightguide plate is disposed underneath the first prism sheet. The second prism sheet is disposed underneath the first lightguide plate. The second prism sheet has a lower surface that has a plurality of mutually parallel elongated prisms. The second lightguide plate is disposed underneath the second prism sheet. The first light source is disposed adjacent to an edge surface of the first lightguide plate to emit light into the first lightguide plate, and the light has an optical axis that is at a predetermined angle to the elongated prisms of the first prism sheet in plan view. The second light source is disposed adjacent to an edge surface of the second lightguide plate to emit light into the second lightguide plate, and the light has an optical axis that is at a predetermined angle to the elongated prisms of the second prism sheet in plan view.

In this backlight unit, when illuminating light is emitted from only the first light source, the light is transmitted through only the first prism sheet, thereby obtaining exiting light having high directivity in the forward direction relative to the display screen. When illuminating light is emitted from only the second light source, the light is transmitted through both the second prism sheet and the first prism sheet, thereby obtaining exiting light having directivity in two obliquely sideward directions relative to the display screen. When illuminating light is emitted from both the first and second light sources, it is possible to obtain exiting light having wide-angle directivity in three directions in combination, i.e. the directly forward direction and two obliquely sideward directions relative to the display screen. Accordingly, it is possible to arbitrarily and rapidly switch among emission of light having high directivity in a single direction, emission of light having directivity in two directions, and emission of light having wide-angle directivity in these three directions in combination by selectively switching between the on/off operations of the first light source and the second light source.

Specifically, the backlight unit may be arranged as follows. The optical axis of light from the first light source is at right angles to the elongated prisms of the first prism sheet in plan view, and the optical axis of light from the second light source is at right angles to the elongated prisms of the second prism sheet in plan view.

More specifically, the elongated prisms of the first prism sheet and the elongated prisms of the second prism sheet may be parallel to each other. In this backlight unit, the above-described directivity can be obtained in a plane perpendicularly intersecting with the prisms of the first and second prism sheets.

In the backlight unit of the present invention, the elongated prisms of the first prism sheet and the elongated prisms of the second prism sheet may be at a predetermined angle to each other in plan view. In this case, it is possible to obtain directivity in which light is polarized in a direction perpendicular to the prisms on the first prism sheet. For example, if the ridges of the prisms on the second prism sheet extend vertically, the ridges of the prisms on the first prism sheet are arranged to extend parallel to a direction perpendicular to the ridges of the prisms on the second prism sheet, i.e. horizontally, whereby it is possible to obtain directivity in which light is polarized vertically.

In addition, the present invention provides a display apparatus including an image display panel and the above-described backlight unit of the present invention that is disposed at the back of the image display panel. The display apparatus further includes a switching control unit that performs on/off switching of the first light source to emit light and that also performs on/off switching of the second light source to emit light. In this display apparatus, it is possible to readily switch between the above-described directivities by arbitrarily switching between the on/off operations of the first and second light sources with the switching control unit.

In the display apparatus, the switching control unit may be arranged to be capable of controlling the amounts of light from the first light source and the second light source, respectively. Light from the second light source passes through two lightguide plates and two prism sheets. Therefore, when reaching the light exit surface, the light from the second light source has been attenuated more than light from the first light source. In this display apparatus, the luminance of exiting light can be kept constant before and after switching between the first and second light sources by setting the amount of light from the second light source is larger than that from the first light source. When the first light source and the second light source are turned on simultaneously, the amounts of light emitted therefrom can be controlled so that the luminance is similar to that when only either of them is turned on.

Further, the display apparatus of the present invention is characterized in that the image display panel is a liquid crystal display panel. That is, this display apparatus is a liquid crystal display apparatus using a liquid crystal display panel. Therefore, the apparatus can be reduced in thickness, weight and cost, and directional-characteristics switchable liquid crystal display can be obtained.

The display apparatus may be used in a car navigation system or an on-board television system. The use of the display apparatus in such a system enables selection of light directivity corresponding to each of the driver's seat, the passenger's seat and the back seat. Accordingly, bright and satisfactory visibility can be obtained at any of these seats.

In the display apparatus of the present invention, the image display panel may be adapted to be capable of displaying different images for a plurality of predetermined directions for viewing the display screen of the image display panel. That is, the display apparatus enables different images to be seen with satisfactory visibility in the respective directions for viewing the display screen of the image display panel.

### BRIEF DESCRIPTION OF THE DRAWINGS

FIG. 1 is a schematic sectional view showing a display apparatus according to a first embodiment of the present invention.

FIG. 2 is a perspective view showing a backlight unit of the display apparatus in FIG. 1.

FIG. 3 is a schematic sectional view showing a mode for obtaining exiting light having a high directivity with the backlight unit shown in FIG. 2.

FIG. 4 is a schematic sectional view showing a mode for obtaining exiting light having directional characteristics in two directions with the backlight unit shown in FIG. 2.

FIG. 5 is a schematic sectional view showing a mode for obtaining exiting light having wide-angle directional characteristics with the backlight unit shown in FIG. 2.

FIG. 6 is a schematic view of a display apparatus according to a second embodiment of the present invention, showing an arrangement in which the extension directions of prisms on first and second prism sheets perpendicularly intersect each other in plan view.

### DETAILED DESCRIPTION OF THE INVENTION

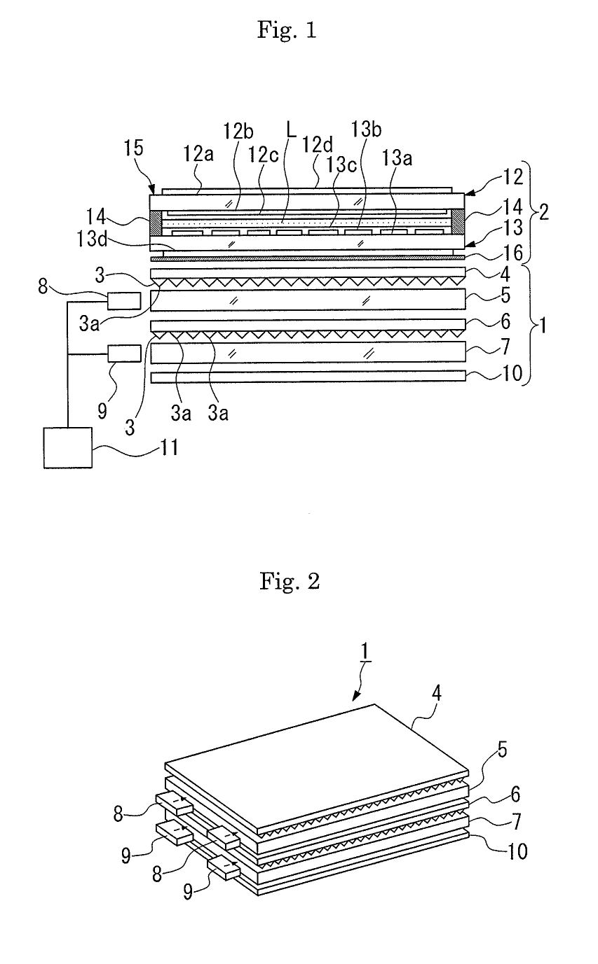

A first embodiment of a backlight unit and display apparatus having the same according to the present invention will be described below with reference to FIGS. 1 to 5.

A backlight unit 1 in this embodiment has, as shown in FIGS. 1 and 2, a first prism sheet 4, a first lightguide plate 5, a second prism sheet 6, a second lightguide plate 7, a first light source 8, a second light source 9, and a reflective sheet 10. The first prism sheet 4 has an upper surface positioned adjacent to the back of a liquid crystal display panel (image display panel) 2 and a lower surface having mutually parallel elongated prisms 3 of triangular cross-section. The first lightguide plate 5 is disposed underneath the first prism sheet 4. The second prism sheet 6 is disposed underneath the first lightguide plate 5 and has a lower surface having mutually parallel elongated prisms 3 of triangular cross-section. The second lightguide plate 7 is disposed underneath the second prism sheet 6. The first light source 8 is disposed adjacent to an edge surface of the first lightguide plate 5 to emit light into the first lightguide plate 5. The second light source 9 is disposed adjacent to an edge surface of the second lightguide plate 7 to emit light into the second lightguide plate 7. The reflective sheet 10 is disposed underneath the second lightguide plate 7.

The display apparatus of this embodiment is a liquid crystal display apparatus used in a car navigation system or an on-board television system, including a liquid crystal display panel 2 and the above-described backlight unit 1 disposed at the back of the liquid crystal display panel 2. The display apparatus further has a switching control unit 11 that is a control circuit capable of switching between the first and second light sources 8 and 9 to emit light.

The liquid crystal display panel 2 is a semi-transmissive liquid crystal display panel and has a panel body 15 having a liquid crystal material L sealed with a sealant 14 in a gap between an upper substrate 12 and a lower substrate 13. A semitransmitting-reflecting sheet 16 having both light-transmitting and light-reflecting functions is provided underneath the panel body 15. As the liquid crystal material L, for example, TN liquid crystal or STN liquid crystal may be used. The upper substrate 12 comprises a transparent substrate 12a made of glass, for example. A transparent electrode 12b made of an ITO (Indium Tin Oxide) film is provided on the lower surface of the transparent substrate 12a. An alignment film 12c is provided on the lower surface of the transparent electrode 12b. The alignment film 12c is formed by applying an alignment treatment to a transparent polyimide resin film or the like. In addition, a polarizer 12d is provided on the upper surface of the transparent substrate 12a.

The lower substrate 13 comprises a transparent substrate 13a made of glass, for example. A transparent electrode 13b made of an ITO film is provided on the upper surface of the transparent substrate 13a. An alignment film 13c is provided on the upper surface of the transparent electrode 13b. The alignment film 13c is formed by applying an alignment treatment to a transparent polyimide resin film or the like. In addition, a polarizer 13d is provided on the lower surface of the transparent substrate 13a.

The semi-transmitting-reflecting sheet 16 may be an aluminum-evaporated sheet formed with light-transmitting properties or a reflective polarizer, for example. It should be noted that a spacer (not shown) comprising silica balls or plastic balls, for example, is dispersedly provided in the gap between the upper and lower substrates 12 and 13, thereby ensuring a desired amount of gap.

The first prism sheet 4 and the second prism sheet 6 are transparent sheet-shaped members that collect light from the first lightguide plate 5 and the second lightguide plate 7 toward their respective upper sides.

The first lightguide plate 5 and the second lightguide plate 7 are formed from a transparent polycarbonate or acrylic resin, for example. The first lightguide plate 5 is adapted so that light is emitted mainly from the upper surface thereof.

The reflective sheet 10 is formed from a metal sheet, film or foil having a light-reflecting function. In this embodiment, a film provided with an evaporated aluminum layer is used as the reflective sheet 10.

The first light source 8 and the second light source 9 comprise a plurality of white light-emitting diodes (LEDs) disposed adjacent to respective edge surfaces of the first and second lightguide plates 5 and 7. The white LEDs are, for example, each formed by sealing a semiconductor light-emitting device on a substrate with a resin material. The semiconductor light-emitting device is, for example, a blue (wavelength λ: 470 to 490 nm) LED device or an ultraviolet (wavelength λ: less than 470 nm) LED device, which is formed, for example, by stacking a plurality of semiconductor layers of a gallium nitride compound semiconductor (e.g. InGaN compound semiconductor) on an insulating substrate, e.g. a sapphire substrate.

The resin material used to seal the semiconductor light-emitting device is formed by adding, for example, YAG fluorescent substance into a silicone resin as a main component. The YAG fluorescent substance converts blue or ultraviolet light from the semiconductor light-emitting device into yellow light, and white light is produced by color mixing effect. It should be noted that various LED devices in addition to those described above can be employed as white LEDs.

The switching control unit 11 is connected to both the first light source 8 and the second light source 9 to control on/off of the first and second light sources 8 and 9 and enables the amounts of light from the first and second light sources 8 and 9 to be controlled in accordance with the on/off control, respectively. More specifically, in a case like that only the second light source 9 is turned on, the switching control unit 11 controls such that the amount of light from the second light source 9 is larger than that from the first light source 8 when it is turned on. In a case like that the first light source 8 and the second light source 9 are turned on simultaneously, the switching control unit 11 controls the amount of light from each of the first and second light sources 8 and 9 to be lower than when only either of them is turned on so that the luminance of exiting light from the exit surface becomes similar to the luminance when only one of the light sources 8 and 9 is turned on.

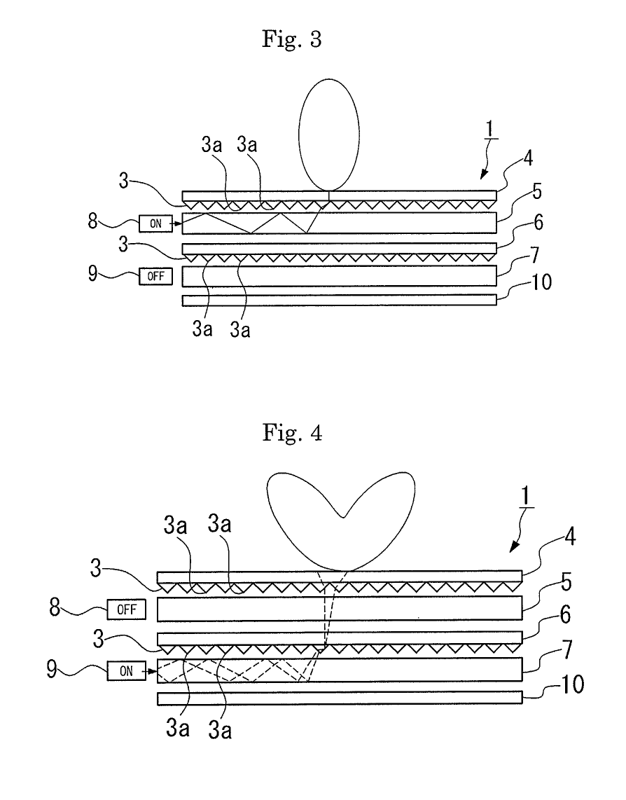

Next, the method of switching directional characteristics of light in the backlight unit and display apparatus in this embodiment will be explained with reference to FIGS. 3 to 5.

First, when the user wants the display apparatus to provide a high directivity in the forward direction relative to the display screen of the liquid crystal display panel 2, the switching control unit 11 is operated to turn on only the first light source 8 to emit light, as shown in FIG. 3. Light emitted from the first light source 8 enters the first lightguide plate 5 in which the light is reflected and refracted to exit upward mainly from the upper surface of the first lightguide plate 5.

The light exiting the upper surface of the first lightguide plate 5 is transmitted through the first prism sheet 4 to exit upward. At this time, the travel direction of light is brought closer to a direction perpendicular to the upper surface of the first prism sheet 4 by the prisms 3 thereof. Thus, the exiting light is made incident on the liquid crystal display panel 2 as illuminating light having a high directivity. Because this illuminating light passes through the liquid crystal display panel 2, the display on the liquid crystal display panel 2 can be viewed at a high luminance when seen from directly in front of the display screen thereof.

When the user wants the display apparatus with directional characteristics in two obliquely sideward directions relative to the display screen of the liquid crystal display panel 2, the switching control unit 11 is operated to turn on only the second light source 9, as shown in FIG. 4. At this time, the switching control unit 11 controls the electric current applied to the second light source 9 so that the luminance of light applied to the liquid crystal display panel 2 is the same as that in the above-described case where only the first light source 8 is turned on.

Light emitted from the second light source 9 enters the second lightguide plate 7 in which the light is reflected and refracted to exit upward mainly from the upper surface of the second lightguide plate 7. It should be noted that, at the lower surface of the second lightguide plate 7, the light is reflected upward by the reflective sheet 10 to exit from the upper surface of the second lightguide plate 7.

The light exiting upward from the second lightguide plate 7 is transmitted successively through the second prism sheet 6, the first lightguide plate 5 and the first prism sheet 4 to exit upward. When the light is transmitted through the second prism sheet 6, the travel direction of light is once brought closer to a direction perpendicular to the upper surface of the second prism sheet 6 by the prisms 3 thereof. However, when transmitted through the first prism sheet 4 subsequently, the light is directed obliquely upward to the left and right relative to the prisms 3 thereof.

Accordingly, illuminating light having directional characteristics in two directions passes through the liquid crystal display panel 2. Therefore, the display on the liquid crystal display panel 2 can be viewed with a higher luminance when seen from obliquely sideward directions relative to the display screen than from directly in front of it. For example, when the display apparatus of this embodiment is used in a car navigation system installed in the center of the instrument panel of a vehicle, it is possible to ensure satisfactory visibility with a high luminance for both the driver in the driver's seat and the occupant in the passenger's seat by switching the system to this setting.

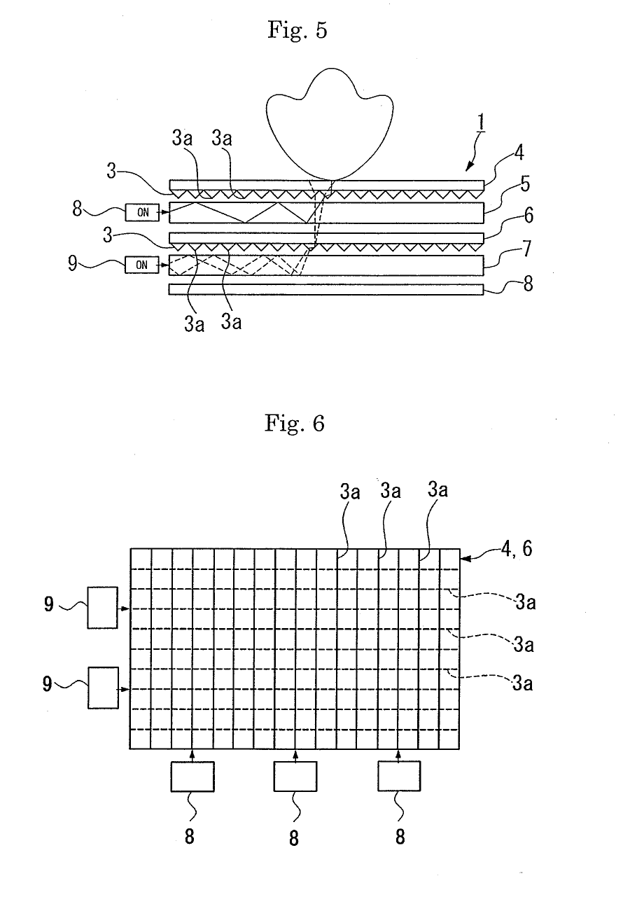

When the user wants the display apparatus to provide directional characteristics in each of three directions, i.e. the forward direction and two obliquely sideward directions relative to the display screen of the liquid crystal display panel 2, the switching control unit 11 is operated to turn on both the first light source 8 and the second light source 9, as shown in FIG. 5. At this time, the switching control unit 11 controls the electric current applied to the first light source 8 and the second light source 9 so that the luminance of light applied to the liquid crystal display panel 2 is the same as that in the above-described case where only one of the first and second light sources 8 and 9 is turned on.

Light emitted from the first light source 8 becomes illuminating light having a high directivity in a single direction through the first prism sheet 4, as stated above. Light emitted from the second light source 9 becomes illuminating light having directional characteristics in two directions through the second prism sheet 6 and the first prism sheet 4, as stated above. Thus, wide-angle illuminating light can be obtained from a combination of these illuminating light.

Because the illuminating light having wide-angle directional characteristics passes through the liquid crystal display panel 2, the display thereon can be seen at a high luminance in a wide angle range, i.e. from a position directly in front of the display screen of the liquid crystal display panel 2 and also from obliquely sideward directions relative to the display screen. For example, when the display apparatus of this embodiment is used in a car navigation system installed in the center of the instrument panel of a vehicle, three persons, i.e. the driver in the driver's seat, the occupant in the passenger's seat and the occupant in the back seat, can view an image of high luminance by switching the system to this setting.

Thus, in this embodiment, the backlight unit has the first prism sheet 4 and the second prism sheet 6, which are stacked up in two stages such that light from the first light source 8 and light from the second light source 9 can enter them disposed above after being transmitted through the first lightguide plate 5 and the second lightguide plate 7, respectively. Therefore, when only the first light source 8 is turned on, light emitted therefrom passes through only the first prism sheet 4, thereby providing a high directivity in the forward direction relative to the display screen. When only the second light source 9 is turned on, light emitted therefrom passes through both the second prism sheet 6 and the first prism sheet 4, thereby providing directional characteristics in two obliquely sideward directions relative to the display screen. When both the first light source 8 and the second light source 9 are turned on to emit light, it is possible to obtain wide-angle directional characteristics in three directions, i.e. the directly forward direction and two obliquely sideward directions relative to the display screen.

In addition, because the switching control unit 11 can control the amounts of light emitted from the first light source 8 and the second light source 9, respectively, the luminance can be kept constant before and after switching between the first and second light sources 8 and 9 by setting the amount of light from the second light source 9 is larger than that from the first light source 8. When the first light source 8 and the second light source 9 are turned on simultaneously, the amounts of light emitted therefrom are controlled so that the luminance is similar to that when only either of them is turned on. By so doing, the luminance can be kept constant between when turning on both the light sources and when turning on either of them.

Thus, it becomes possible to arbitrarily and rapidly switch between a high directivity in a single direction, directional characteristics in two directions, and wide-angle directional characteristics by selectively switching between the on/off operations of the first light source 8 and the second light source 9. Particularly, the use of the display apparatus in a car navigation system or an on-board television system enables selection of a luminance corresponding to each of the driver's seat, the passenger's seat and the back seat. Accordingly, bright and satisfactory visibility can be obtained at any of these seats.

Next, a second embodiment of the backlight unit and display apparatus according to the present invention will be explained with reference to FIG. 6. It should be noted that the same constituent elements as those described in the foregoing first embodiment are denoted by the same reference numerals as used in the first embodiment, and a description thereof is omitted herein.

The second embodiment differs from the first embodiment in that in the first embodiment the prisms 3 of the first prism sheet 4 and the prisms 3 of the second prism sheet 6 are disposed parallel to each other, whereas in the backlight unit and display apparatus of the second embodiment the prisms 3 of the first and second prism sheets 4 and 6 are disposed to perpendicularly intersect each other, as shown in FIG. 6.

Further, the first light source 8 is disposed adjacent to an edge surface of the first prism sheet 4 that is parallel to the prisms 3 thereof. Similarly, the second light source 9 is disposed adjacent to an edge surface of the second prism sheet 6 that is parallel to the prisms 3 thereof. In FIG. 6, the prisms 3 of the second prism sheet 6 are shown by the solid lines, and the prisms 3 of the first prism sheet 4 are shown by the dashed lines.

Accordingly, in the second embodiment, the prisms 3 of the first prism sheet 4 provide directivity in two vertically oblique directions (as viewed in FIG. 6). Directivity in any directions can be obtained by adopting an arrangement in which the first prism sheet 4 is arbitrarily rotatable relative to the second prism sheet 6.

Although some embodiments of the present invention have been described above, the present invention is not necessarily limited to the foregoing embodiments but can be modified in a variety of ways without departing from the scope of the present invention.

For example, although in the foregoing embodiments the optical axis of light from each linear light source intersects the prisms 3 of the associated prism sheet perpendicularly, i.e. at an angle of 90°, the optical axis need not necessarily intersect the prisms 3 at right angles.

Although it is preferable to use white LEDs as the first light source 8 and the second light source 9, as has been stated above, linear fluorescent tubes may also be used as the first and the second light sources 8 and 9.

Further, although in the foregoing embodiments the amount of light from the second light source 9 is set to larger than that from the first light source 8, it is also possible to increase the total amount of light from the second light source 9 by using a larger number of white LEDs for the second light source 9 than for the first light source 8.

Although in the foregoing embodiments a single, that is, the same image is displayed on the entire liquid crystal display panel 2, it is also possible to display different images for predetermined directions, e.g. the forward direction and obliquely sideward directions relative to the display screen. In this case, the backlight unit is arranged so that exiting light has directional characteristics in the predetermined directions relative to the display screen, thereby enabling a satisfactory image of high luminance to be viewed from each of the directions. For example, in a case where a car navigation system is installed in the center of the instrument panel of a vehicle and it is desired so that map information on the display screen can be viewed from the direction of the driver's seat and, at the same time, a television image can be viewed from the direction of the passenger's seat, the backlight unit of the present invention should be set so that exiting light has directional characteristics in two (left and right) directions.

Although in the foregoing embodiments a liquid crystal display panel is employed as an image display panel, other types of image display panels may be used, for example, an electronic paper.

Although in the foregoing embodiments the display apparatus is used in a car navigation system or an on-board television system, it may also be applied to other display purposes, for example, price display.

Further, a plurality of backlight units of the present invention may be arranged to correspond to a large-area display screen, and the directivity of each backlight unit may be made controllable, respectively.

1. A backlight unit comprising:
a first prism sheet having a lower surface that has a plurality of mutually parallel elongated prisms;
a first lightguide plate disposed underneath said first prism sheet;
a second prism sheet disposed underneath said first lightguide plate, said second prism sheet having a lower surface that has a plurality of mutually parallel elongated prisms;
a second lightguide plate disposed underneath said second prism sheet;
a first light source disposed adjacent to an edge surface of said first lightguide plate to emit light into said first lightguide plate, said light having an optical axis that is at a predetermined angle to the elongated prisms of said first prism sheet in plan view; and
a second light source disposed adjacent to an edge surface of said second lightguide plate to emit light into said second lightguide plate, said light having an optical axis that is at a predetermined angle to the elongated prisms of said second prism sheet in plan view.

2. The backlight unit of claim 1, wherein said optical axis of light from said first light source is at right angles to the elongated prisms of said first prism sheet in plan view, and said optical axis of light from said second light source is at right angles to the elongated prisms of said second prism sheet in plan view.

3. The backlight unit of claim 2, wherein the elongated prisms of said first prism sheet and the elongated prisms of said second prism sheet are parallel to each other.

4. The backlight unit of claim 1, wherein the elongated prisms of said first prism sheet and the elongated prisms of said second prism sheet are at a predetermined angle to each other in plan view.

5. A display apparatus comprising:
an image display panel;
the backlight unit of claim 1, said backlight unit being disposed at a back of said image display panel; and
a switching control unit that performs on/off switching of said first light source to emit said light and that also performs on/off switching of said second light source to emit said light.

6. The display apparatus of claim 5, wherein said switching control unit can control amounts of light from said first light source and second light source, respectively.

7. The display apparatus of claim 5, wherein said image display panel is a liquid crystal display panel.

8. The display apparatus of claim 5, which is used in a system such as a car navigation system and an on-board television system.

9. The display apparatus of claim 5, wherein said image display panel can display different images in a plurality of predetermined directions for a display screen of said image display panel being viewed.
